(19) United States
(12) Patent Application Publication
(10) Pub. No.: US 2026/0039069 A1
(43) Pub. Date: Feb. 5, 2026

(54) MICRO RF CONNECTOR PLUG, PROCESSING PROCESS THEREFOR, AND CONNECTOR

(71) Applicant: Amphenol-Kai Jack (Shenzhen) Inc., Guangdong, Guangdong (CN)

(72) Inventors: Owen R. BARTHELMES, Putnam Valley, NY (US); Zhu LIWEI, Guangdong, Guangdong (CN)

(21) Appl. No.: 18/995,370

(22) PCT Filed: Jul. 20, 2023
(86) PCT No.: PCT/US2023/028260

§ 371 Date: Jan. 16, 2025

(30) Foreign Application Priority Data
Jul. 20, 2022 (CN) 202210862311.3

(51) Int. Cl. H01R 24/40; H01R 13/623; H01R 43/24; H01R 103/00

(52) U.S. Cl. CPC H01R 24/40; H01R 13/623; H01R 43/24; H01R 2103/00

(57) ABSTRACT

Micro RF connector plugs, assemblies thereof, and methods of processing such plugs are described. The RF plugs include an outer conductor (2) having an outer conductor ring (201) with a plurality of pins (202) extending therefrom and an axis therethrough. An inner conductor (1) arranged within the outer conductor includes a central needle (101) along the axis and an extending needle (102) in a direction normal to the axis and extending through a gap between two adjacent pins of the outer conductor. An insulator (3) isolates the inner conductor from the outer conductor and includes an outer ring (301), an inner ring (302), and a base (303) connecting the outer and inner ring. The outer conductor ring is embedded between the outer and the inner ring. First and second locking structures (203, 304) are configured to securely connect and lock the connector plug into connection with a connector receptacle.

### CROSS REFERENCE TO RELATED APPLICATIONS

This application claims the benefit of CN application Ser. No. 202210862311.3, filed on Jul. 20, 2022, which is incorporated herein by reference in its entirety.

### FIELD OF THE INVENTION

The present invention relates to the technical field of electric connection devices, and specifically, to a micro radio frequency (RF) connector plug, a processing process therefor, and a connector.

### BACKGROUND OF THE INVENTION

Radio frequency (RF) connectors are used for realizing connection and disconnection of electric signals, and the structure thereof mainly comprises an RF line, a connection plug, a connection receptacle, and a circuit board. The RF line may be connected with the connection plug to form a male end assembly of a connector. The connection receptacle may be connected with the circuit board to form a female end assembly of the connector. With the rise of 5G mobile networks, RF connectors, such as used in the automobile and other industries, are becoming increasingly large-scale, and RF connectors are gradually developing in the directions of low cost, compactness, automation, and the like.

Illustrative configurations of two common micro-RF connector plugs currently on the market are shown in FIG. 1 and FIG. 2. The connector plug shown in FIG. 1 has an outer conductor that is processed with a stretch film, and when the outer conductor is processed, a fixing structure is needed to fix the outer conductor, leading to a high total processing cost. The connector plug shown in FIG. 2 has an outer conductor made of a zinc alloy, and thus the material cost is relatively high. As a result of these limitations of the prior configurations it may be difficult to realize automated production. Additionally, for outer conductors according to the prior art, both the inner wall and the outer wall of the conductors includes smooth cavity bodies. As a result, after a plug is inserted into a receptacle, the structures may tend to become detached. Furthermore, it may be difficult to determine whether the plug is in place and properly connected or seated.

In view of the above and other considerations, including that the prior configurations of such plug and the receptacle tend to become detached after they are plugged together and that it is not conducive to the implementation of automated production of connector plugs, it is desirable to provide a micro RF connector plugs, a processing process thereof, and a connector.

### SUMMARY OF THE INVENTION

To solve the above technical problems and other issues or problems and to provide further advantages and features, embodiments of the present disclosure are directed to providing a micro RF connector plug, a processing process thereof, and a connector. Various non-limiting and non-exhaustive objectives of embodiments of the present disclosure are to prevent a plug and a receptacle from easily becoming detached after they are plugged together, and to be conducive to automated production processes for such connector plugs.

In accordance with some embodiments, micro RF connector plugs are provided. The micro RF connector plus include an inner conductor, an outer conductor, and an insulator for isolating the inner conductor from the outer conductor. The outer conductor includes an outer conductor ring. Several pins extend radially and outwardly from a bottom end of the connector ring and may be arranged circumferentially on the bottom end thereof. The inner conductor includes a central needle arranged in an axial direction of the outer conductor ring and an extending needle arranged in the axial direction of the outer conductor ring. The extending needle is configured to extend from a gap between two adjacent pins and toward the outer side of the outer conductor ring. The insulator of the micro RF connector plugs include an outer ring, an inner ring, and a base connecting the outer ring and the inner ring. The outer ring and the inner ring are arranged coaxially, an outer edge of the base is connected with a bottom end surface of the outer ring, and an inner edge of the base is connected with a bottom end surface of the inner ring. The outer conductor ring is embedded between the outer ring and the inner ring and is configured to limit the movement of the outer conductor. A first locking structure is provided on the inner wall of the outer conductor ring. A second locking structure is provided on the outer wall of the outer ring. The first locking structure and the second locking structure are configured to lock to a connector receptacle into which the connector plug is inserted.

In accordance with some embodiments, the first locking structure is a ring-shaped first groove, the first groove having a first side wall, a first upper wall, and a first lower wall. The first side wall is arranged to be parallel to an axis of the outer ring. The first upper wall inclines upwardly and forms an obtuse-angle structure with the first side wall and the first lower wall inclines downwardly and forms an obtuse-angle structure with the first side wall.

In accordance with some embodiments, the second locking structure is a ring-shaped second groove, the second groove having a second side wall, a second upper wall, and a second lower wall. There is a certain angle between the second side wall and the axis of the outer ring. The top end of the second side wall is arranged to incline to the inner side of the outer ring and the second upper wall and the second lower wall are both arranged to be horizontal.

In accordance with some embodiments, there is a certain gap between the outer ring and the inner ring. The bottom end surface of the outer conductor ring is embedded in the gap, and the pins extend radially from the base. A block that extends inwardly is arranged on the top end surface of the inner wall of the outer ring and the top end surface of the outer conductor ring abuts the bottom surface of the block.

In accordance with some embodiments, a ring-shaped groove is provided on the inner side wall of the outer ring. A protrusion corresponding to the ring-shaped groove is provided on the outer side wall of the outer conductor ring and the protrusion is embedded into the ring-shaped groove.

In accordance with some embodiments, the outer ring and the inner ring are provided with a separation board that is arranged in a radial direction of the outer ring.

In accordance with some embodiments, a square hole is provided at a central axis of the inner ring. The central needle is arranged inside the square hole. A conical frustrum is provided at the central axis of the top surface of the inner ring. A through hole in communication with the square hole is provided at the central position of the conical frustrum and the diameter of the through hole inside the conical frustrum is smaller than a side length of the square hole.

In accordance with some embodiments, a notch is provided on the side wall of the outer conductor ring and the notch is arranged parallel to the axial direction of the outer conductor ring and runs through the inner wall and the outer wall of the outer conductor ring.

In accordance with some embodiments, the pins are connected with the outer conductor ring by means of a rounded angle and an opening is formed at the place of the rounded angle.

In accordance with some embodiments, the pins include four first pins and one second pin. The four first pins are evenly distributed in the circumferential direction of the outer conductor ring and the second pin is arranged to oppose the extending needle. An opening is formed at the connection between the rounded angle and a first pin and the outer conductor ring.

In accordance with some embodiments, a rounded angle is provided at the connection between the central needle and the extending needle, and a step is formed at the bottom end of the central needle.

The present disclosure further provides for micro RF connectors. The micro RF connectors include a plug and a receptacle, the plug adopts the above-described micro RF connector plug. The receptacle includes a housing, an outer conductor, and an inner conductor that are arranged in an order from outside to inside. The housing is an insulator and one side wall of the housing is provided with an external hook. An internal buckle is provided at a bottom end of the outer conductor of the receptacle and the inner conductor of the receptacle is arranged in contact and electrically connected with the inner conductor of the plug. The external hook is engaged with the second locking structure and the internal buckle is engaged with the first locking structure.

The present disclosure further provides for processing processes of micro RF connector plugs that is applied to the above-described micro RF connector plug. The process includes processing inner conductors and outer conductors using continuous stamping, placing stamped inner conductors located on a strip in a lower mold of an injection mold, and placing stamped outer conductors located on a strip in the injection mold. The inner conductors and the outer conductors are arranged to oppose each other, a central needle of an inner conductor is placed at the central axis of an outer conductor, and the bottom surface of the inner conductor is flush with the bottom surface of the outer conductor. The process further includes placing an upper mold of the injection mold and injection molding an insulator, with the insulator being injection molded with the inner conductor and the outer conductor into an integral molded part.

In accordance with some embodiments, the strip for processing inner conductors comprises a first positioning part and a first stamping part. Several positioning holes are evenly arranged on the first positioning part. Inner conductors are made by stamping the first stamping part. The processed first stamping part includes inner conductors, first protection pins, and one first protection pin is provided between every two adjacent inner conductors. The extending needle of the inner conductor is connected to the first positioning part.

In accordance with some embodiments, the strip for processing outer conductors includes a second positioning part and a second stamping part. Several positioning holes are evenly arranged on the second positioning part. Outer conductors are made by stamping the second stamping part. The processed second stamping part includes outer conductors, second protection pins, and one second protection pin is provided between every two adjacent outer conductors. The second pin of the outer conductor is connected to the second positioning part.

In accordance with some embodiments, the space between the positioning holes on the first positioning part is equal to the space between the positioning holes on the second positioning part.

In accordance with some embodiments, the first protection pin comprises a horizontal bottom plate, a vertical plate that is vertically connected with the bottom plate, and a reinforcing plate arranged at the top end of the vertical plate. The reinforcing plate is arranged horizontally and extends toward the first positioning part and the length of the reinforcing plate is shorter than the length of the bottom plate.

Advantageously, embodiments of the present disclosure provide, advantages, including but not limited to the following.

For example, in some embodiments, a connector plug according to the present disclosure provides a first locking structure on an inner wall of an outer conductor and provides a second locking structure on an outer wall of an insulator to achieve double locking. Furthermore, in accordance with some embodiments, a ring-shaped groove may be provided on an inner wall of an insulator for locking with an outer conductor. After the connector plug is inserted into the receptacle, a double locking is achieved through the first locking structure and the second locking structure. Advantageously, in some embodiments, the outer conductor and the insulator may be clamped through a ring-shaped groove, such that it is not easy for the receptacle to become detached. In accordance with some embodiments, a specific structure and/or shape of the first locking structure and the second locking structure may be defined, which, while ensuring the strength of the insulator, not only can lock the receptacle, but also may facilitate the plug to be pulled out of the receptacle, leading to easy use.

Advantageously, in accordance with some embodiments, the inner conductor and the outer conductor of the connector plug may both be processed using continuous stamping. The processed inner conductor and outer conductor may be located on strips and may be arranged opposing to each other on an injection mold. An insulator is injection molded and the insulator, the inner conductor, and the outer conductor are injection molded into an integral molded part. Advantageously, the plug structure may be stable and while also eliminating a need for assembly, which is conducive to automated production and improvement of production efficiency.

Furthermore, advantageously, in accordance with some embodiments, when inner conductors and outer conductors are processed, protection pins may be provided on the strips of inner conductors and outer conductors, which can improve the processing quality of the inner conductors and the outer conductors. Compared with prior configurations, the rejection rate of inner conductors and outer conductors may be lowered by up to 80%.

### BRIEF DESCRIPTION OF THE DRAWINGS

FIG. 1 is a schematic illustration of a connector plug according to the prior art;

FIG. 2 is a schematic illustration of another connector plug according to the prior art;

FIG. 3 is a schematic illustration of an external structure of a connector plug according to an embodiment of the present disclosure;

FIG. 4 is a schematic illustration of an internal structure of the connector plug according to an embodiment of the present disclosure;

FIG. 5 is a cross-sectional view of the connector plug of FIG. 4 viewed along the line A-A;

FIG. 6 is a schematic illustration of an outer conductor according to an embodiment of the present disclosure;

FIG. 7 is a schematic illustration of an inner conductor according to an embodiment of the present disclosure;

FIG. 8 is a schematic illustration of an insulator according to an embodiment of the present disclosure;

FIG. 9 is a schematic illustration of a connector according to an embodiment of the present disclosure;

FIG. 10 is a schematic illustration of a strip of inner conductors according to an embodiment of the present disclosure; and

FIG. 11 is a schematic illustration of a strip of outer conductors according to an embodiment of the present disclosure.

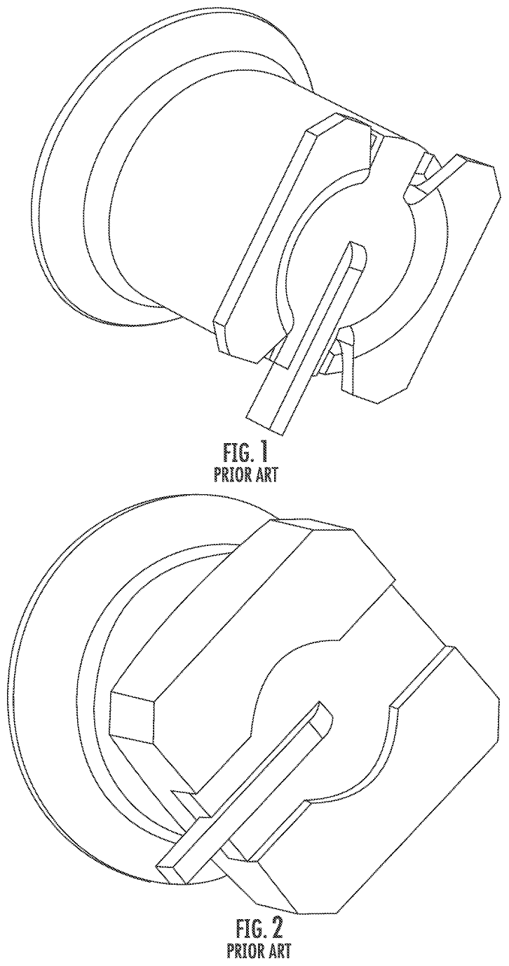

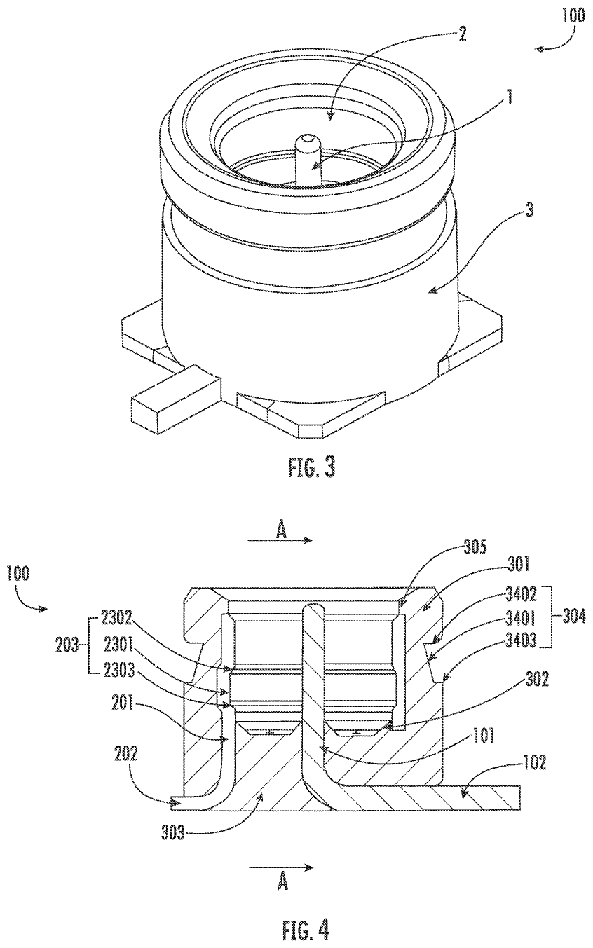

### DETAILED DESCRIPTION

The technical aspects, solutions, and advantages of the present disclosure will be clearly described below with reference to the accompanying drawings. It will be appreciated that the described embodiments are not all embodiments of the present disclosure, and other embodiments that may be apparent to those of ordinary skill in the art are intended to be captured by the present disclosure.

It should be noted that directional or positional relationships indicated by terms, “center,” “upper,” “lower,” “left,” “right,” “vertical,” “horizontal,” and the like, are directional or positional relationships shown on the basis of the drawings, and are only for facilitating the description of the embodiments of the present disclosure and simplifying the description, but do not indicate or imply that the indicated devices or elements must have a particular position, or be constructed and operated at the particular position. Therefore, it is to be understood that such directional language is not intended to be limiting on the scope of the present disclosure, but rather is provided for explanatory and illustrative purposes.

Referring to FIGS. FIGS. 3-5, schematic illustrations of a micro RF connector plug 100 in accordance with an embodiment of the present disclosure are shown. In some non-limiting embodiments, the micro RF connector plug illustrated in this embodiment may be configured for use with or operation within an automobile, farm equipment, robotics, imaging device, and the like. As shown in FIG. 3, the micro RF connector plug 100 includes an inner conductor 1, an outer conductor 2, and an insulator 3 for isolating the inner conductor 1 from the outer conductor 2. As shown in FIGS. 4-5, the outer conductor 2 includes an outer conductor ring 201. Several pins 202 extend radially and outwardly on a bottom end of the outer conductor ring 201. The pins 202 may be provided circumferentially about the bottom end of the outer conductor ring 201. The inner conductor 1 includes a central needle 101 arranged or oriented in an axial direction of the outer conductor ring 201. That is, the central needle 101 is arranged centrally within the outer conductor ring 201 and arranged along an axis passing through a center of the outer conductor ring 201. An extending needle 102 is arranged in a radial direction of the outer conductor ring 201 (e.g., extending radially outward from the axial direction). Stated another way, the extending needle 102 extends in a direction normal to the directed of the central needle 101. The extending needle 102 may extends through or from a gap between two adjacent pins 202 of the outer conductor 2 and toward an outer side of the outer conductor ring 201.

The insulator 3 includes an outer ring 301, an inner ring 302, and a base 303 connecting the outer ring 301 and the inner ring 302. The outer ring 301 and the inner ring 302 are arranged coaxially. An outer edge of the base 303 of the insulator 3 is connected with a bottom end surface of the outer ring 301, and an inner edge of the base 303 is connected with a bottom end surface of the inner ring 302.

The outer conductor ring 201 is embedded between the outer ring 301 and the inner ring 302 of the insulator 3. As such, movement of the outer conductor 2 may be limited. A first locking structure 203 is provided on an inner wall of the outer conductor ring 201. A second locking structure 304 is provided on an outer wall of the outer ring 301. The first locking structure 203 and the second locking structure 304 are used for locking to a connector receptacle into which the connector plug is inserted.

In accordance with some non-limiting embodiments, the inner conductor 1 and the outer conductor 2 may both be made of a copper alloy. Such a copper alloy may provide excellent mechanical performance and electrical performance. In addition, according to some embodiments of the present disclosure, a plug and a receptacle of connectors may be locked by means of the first locking structure 203 and the second locking structure 304. Accordingly, when the connector plug is inserted into the receptacle, a positive feedback or mechanical feedback can inform a user that the plug is properly connected or seated in place. This can prevents poor contact caused by improper assembly. Additionally, such locking structures 203, 304 can results in a high securing or locking force after the insertion to thus prevent the connector receptacle from becoming detached. Accordingly, advantageously, embodiments of the connectors described herein can be used in adverse environments.

As shown and in accordance with some embodiments of the present disclosure, the first locking structure 203 is a ring-shaped first groove. The first groove, as shown in FIG. 4, is defined by a first side wall 2301, a first upper wall 2302, and a first lower wall 2303. The first side wall 2301 is arranged to be parallel to the axis of the outer ring 301. The first upper wall 2302 inclines upwardly and forms an obtuse-angle structure with the first side wall 2301. The first lower wall 2303 inclines downwardly and forms an obtuse-angle structure with the first side wall 2301.

Similarly, in this illustrative configuration, the second locking structure 304 is a ring-shaped second groove. The second groove is defined by a second side wall 3401, a second upper wall 3402, and a second lower wall 3403. As shown, there is a certain angle between the second side wall 3401 and the axis of the outer ring 301. That is, there the second side wall 3401 is arranged at an angle relative to an axis of the outer ring 301 (or an axis passing through the outer conductor). As such, the second side wall 3401 is not arranged parallel or normal to an axis through the outer ring 301 (or an axis through the outer conductor). The top end of the second side wall 3401 is arranged to incline to the inner side of the outer ring 301. The second upper wall 3402 and the second lower wall 3403 are both arranged to be horizontal or normal to the axis of the outer ring 301.

In accordance with some embodiments, there is a certain gap 115 (e.g., spacing, separation, etc.) between the outer ring 301 and the inner ring 302. A bottom end surface of the outer conductor ring 201 is embedded in the gap. The pins 202 extend radially from the base 303. A block 305 extends inwardly on a top end surface of the inner wall of the outer ring 301, as shown in FIGS. 4-5. A top end surface of the outer conductor ring 201 may abut a bottom surface of the block 305.

A ring-shaped groove 306 (FIG. 8) is provided on an inner side wall of the outer ring 301. A protrusion corresponding to the ring-shaped groove 306 is provided on the outer side wall of the outer conductor ring 201. The protrusion is embedded into the ring-shaped groove 306 to form the first locking structure 203.

In accordance with some embodiments, the outer ring 301 and the inner ring 302 are provided with a separation board 307 (FIG. 8), and the separation board 307 is arranged in the radial direction of the outer ring 301.

A square hole is provided at the central axis of the inner ring 302. The central needle 101 of the inner conductor 1 may be arranged inside the square hole. A conical frustrum 308 is provided at the central axis of the top surface of the inner ring 302. A through hole formed in a central position of the conical frustrum 308 is arranged in communication with the square hole and the diameter of the through hole inside the conical frustrum 308 is smaller than a side length of the square hole. Accordingly, the central needle 101 may be installed within and through both the square hole (shaped to hold the central needle 101 in place/position) and the through hole of the conical frustrum 308. Several optional grooves 111 may be on the top surface of the inner ring 302. In accordance with some non-limiting embodiments, the depth of the grooves 111 formed on the top surface of the inner ring 302 is about 0.1 mm. The purpose of such grooves 111 may be to control overflowing glue inside the grooves during injection molding, improving the molding quality of the top surface of the inner ring, and reducing burr. A chamfer 113 inclined toward the central axis is provided at the edge of the top surface of the inner ring, which facilitates the overflowing glue to flow towards the inner side and be controlled inside the grooves.

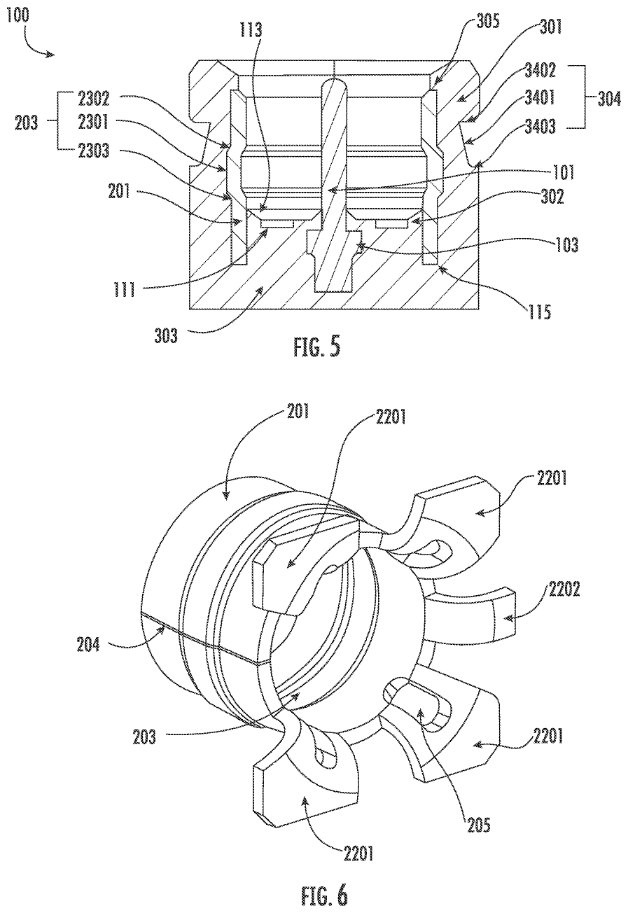

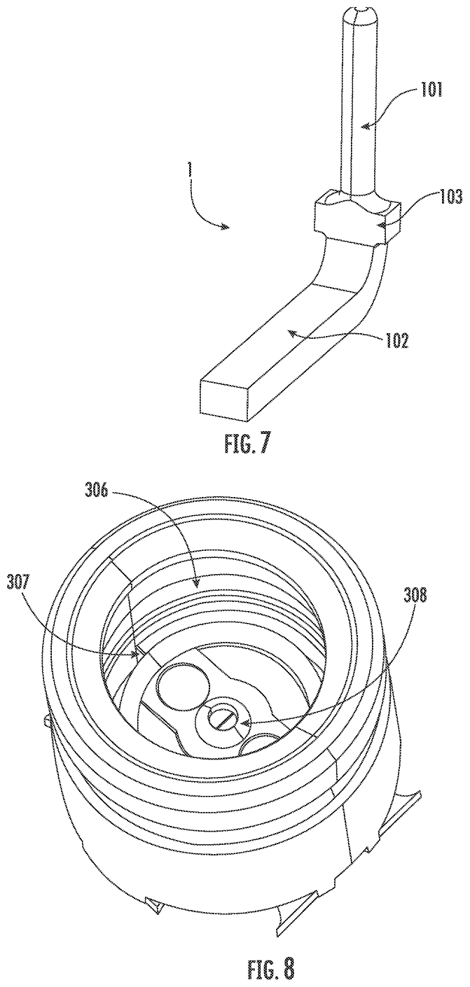

As shown in FIG. 6, a notch 204 is provided on the side wall of the outer conductor ring 201. The notch 204 is arranged or oriented parallel to the axial direction of the outer conductor ring 201 and runs through the inner wall and the outer wall of the outer conductor ring 201. The separation board 307 arranged between the outer ring 301 and the inner ring 302 is embedded into the notch 204 on the outer conductor ring 201. If the insulator 3 and the outer conductor 2 both are parts that are completely axially symmetrical, the outer conductor 2 tends to undergo deviation and rotation during use, which then leads to some issues of poor contact or misaligned pins. Therefore, rotation between the outer conductor 2 and the insulator 3 is prevented by the engagement between the notch 204 of the outer conductor 2 and the separation board 307.

In accordance with some embodiments, the pins 202 are connected with the outer conductor ring 201 by means of a rounded angle, and an opening 205 (FIG. 6) is formed at the place of the rounded angle. In this illustrative embodiment, the pins 202 are illustrated as four first pins 2201 and one second pin 2202. The four first pins 2201 are evenly distributed about the circumference of the outer conductor ring 201. The second pin 2202 is arranged to oppose the extending needle 102, which are separately arranged on two sides of the outer conductor ring 201. That is, when assembled, the second pin 2202 and the extending needle 102 are arranged opposite from each other relative to the central axis. The opening 205 is formed at the place of the rounded angle connection between a first pin 2201 and the outer conductor ring 201. The provision of the opening 205 at the place of the rounded angle connection of the first pin 2201 serves to facilitate the rounded molding. That is, the bending process of the pins and the size stability is improved when the pins are bent as shown and described.

Referring to FIG. 7, a schematic illustration of the inner conductor 1 is shown. The inner conductor 1 includes a rounded angle that is provided at a connection between the central needle 101 and the extending needle 102. A step 103 is formed at the bottom end of the central needle 101. As illustrated, the cross section of the extending needle 102 is squared (e.g., square, rectangular, or the like), and the cross section of the central needle 101 is circular, the cross section of the step 103 is squared (e.g., square, rectangular, or the like). The structure of the step 103 may include square blocks that extend symmetrically on two sides of the central needle 101. The step 103 can be used to fix the inner conductor 1 inside the insulator 3. That is, the shape of the step 103 may fit within the through holes (e.g., square hole & through hole) described above.

Referring now to FIG. 9, a schematic illustration of a micro RF connector 500 is shown. As shown in FIG. 9, the micro RF connector 500 includes a plug 501 and a receptacle 502. The plug 501 may be arranged similar to the above-described micro RF connector plug, shown and described above. The receptacle 502, as shown, includes a housing 8, an outer conductor 9, and an inner conductor 10 that are arranged in an order from outside to inside. The housing 8 of the receptacle 502 may be an insulator or formed from insulating material. The housing 8 is provided with an external hook 801, such as arranged on one or more locations of an interior sidewall of the housing 8. An internal buckle 901 may be provided at a bottom end of the outer conductor 9 of the receptacle 502 and the inner conductor 10 of the receptacle may be arranged in contact and electrically connected with the inner conductor 1 of the plug 501. As shown, the external hook 801 is engaged with the second locking structure 304 of the plug 501 and the internal buckle 901 is engaged with the first locking structure 203 of the outer conductor ring 201 (described above).

Embodiments of the present disclosure are also directed to a processing process of a micro RF connector plug that is applied to the above-described micro RF connector plug.

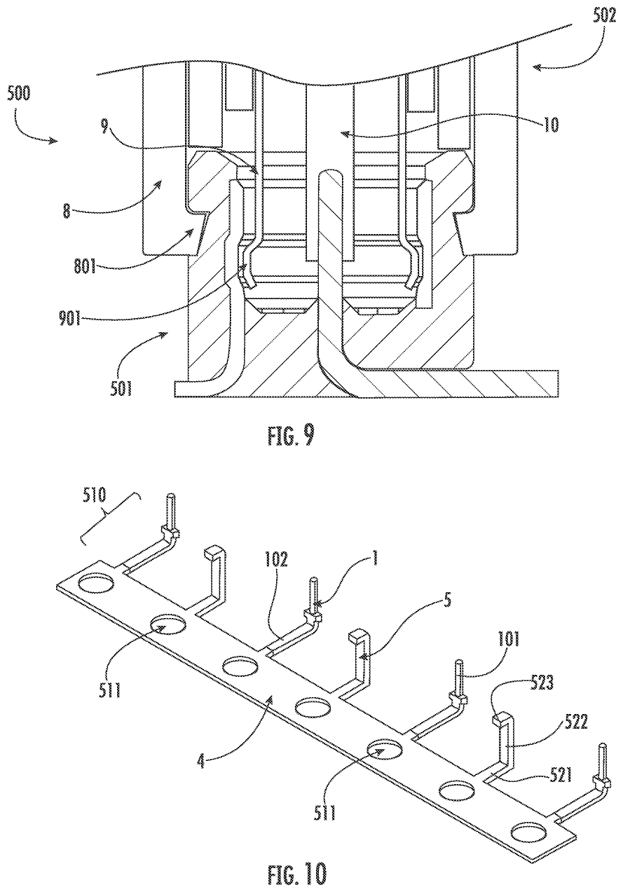

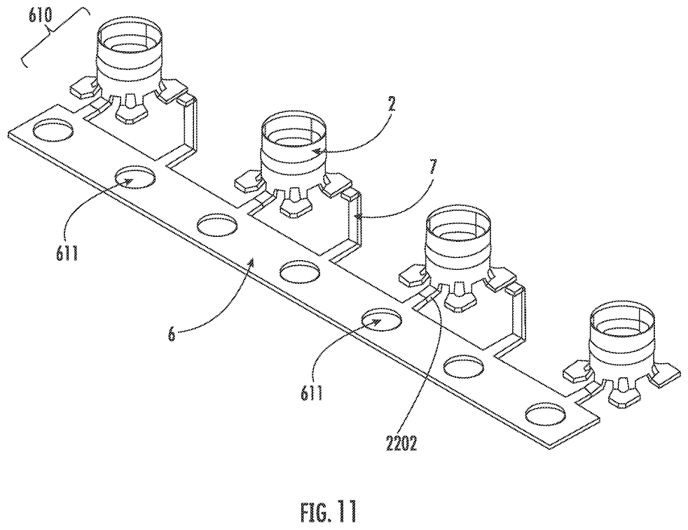

The process includes processing multiple inner conductors 1 (e.g., shown in FIG. 10) and outer conductors 2 (e.g., shown in FIG. 11) using continuous stamping. The stamped inner conductors 1, located on a strip, are placed in a lower mold of an injection mold. The stamped outer conductors 2, also located on a strip, are placed in the injection mold. The inner conductors 1 and the outer conductors 2 are arranged to oppose each other. A central needle 101 of an inner conductor 1 is placed at the central axis of an outer conductor 2 and the bottom surface of the inner conductor 1 is arranged flush with the bottom surface of the outer conductor 2. An upper mold of the injection mold is provided and an insulator 3 is injection molded. The insulator 3 is injection molded with the inner conductor 1 and the outer conductor 2 into an integral molded part.

As shown in FIG. 10, the strip for processing inner conductors 1 comprises a first positioning part 4 and a first stamping part 510. Several positioning holes 511 are evenly arranged on the first positioning part 4. The inner conductors 1 are made by stamping the first stamping part 510. The processed first stamping part 510 includes inner conductors 1 and first protection pins 5. One first protection pin 5 is provided between every two adjacent inner conductors 1 along the first positioning part 4. The extending needle 102 of the inner conductor 1 is connected to the first positioning part 4. The first protection pins 5 prevents the inner conductors 1 from deforming when the inner conductors 1 are processed. The processing precision of the inner conductors 1 may thus be improved. As a result, the processing precision of the connector plug may be improved.

As shown in FIG. 11, the strip for processing outer conductors 2 comprises a second positioning part 6 and a second stamping part 610. Several positioning holes 611 are evenly arranged on the second positioning part 6. The outer conductors 2 are made by stamping the second stamping part 610. The processed second stamping part 610 includes outer conductors 2 and second protection pins 7. One second protection pin 7 is provided between every two adjacent outer conductors 2 along the second positioning part 6. The second pin 2202 of each outer conductor 2 is connected to the second positioning part 6. The second protection pins 7, the outer conductors 2 do not tend to deform when the outer conductors 2 are processed. As a result, the processing precision of the outer conductors 2 may be improved and thus the processing precision of the connector plug may be improved.

In accordance with some embodiments, the space between the positioning holes 511 on the first positioning part 4 is equal to the space between the positioning holes 611 on the second positioning part 6.

As shown in FIG. 10, the first protection pins 5 each include a horizontal bottom plate 521, a vertical plate 522 that is vertically connected with the bottom plate 521, and a reinforcing plate 523 arranged at the top end of the vertical plate 522. The reinforcing plate 523 is arranged horizontally (i.e., parallel with the first positioning part 4). The reinforcing plate 523 extends toward the first positioning part 4, and the length of the reinforcing plate 523 is shorter than the length of the bottom plate 521. As illustratively shown in FIG. 11, the second protection pins 7 that extend from and are part of the second positioning part 6 may have substantially similar structure.

Because the injection molding method is used to integrally mold the insulator, the inner conductor, and the outer conductor of the connector plug, the connector plugs of the present disclosure do not require subsequent or additional assembly. Furthermore, such assembly/manufacturing process allows for the structure of the connector plugs to be made very small (e.g., as compared to prior configurations). For example, and without limitation, the outer diameter of the insulator can be made to be about 3.88 mm. Such size can expand the application range of the connector plug. Further, such structure and assembly processes may make it easy to realize automated production, improve production efficiency, and lower production costs.

The above described micro high-frequency radio frequency (RF) connectors, receptacles, components, and methods of assembly thereof may be used for a variety of purposes, applications, and within a variety of industries. For example, and without limitation, the disclosed configurations may be used in the automobile industry for data transfer, communication, and the like. In some configurations, the connectors and associated components disclosed herein may be used for cameras onboard automobiles. In some configurations, embodiments of the present disclosure may be used for data connections onboard automobiles. In accordance with some embodiments, the disclosed configurations may be used for farming equipment and/or robotic equipment (e.g., imaging, sensor data transmission, etc.). In some embodiments, the connectors and other components disclosed herein may be used in devices for wireless communication (e.g., 5G, Wi-Fi, Zigbee, etc.), such as modems and the like. Those of skill in the art will appreciate that the disclosed embodiments and variations thereon may be used for any RF connector applications, and thus the disclosed embodiments are not intended to be limiting to any specific or particular use and/or application thereof.

The above description merely contains embodiments of the present invention, which are not intended to limit the patent scope of the present invention. Any equivalent structure or equivalent flow change made according to the description and the accompanying drawings of the present invention, or direct or indirect applications in other related technical fields, shall be encompassed by the patent protection scope of the present invention.

As used herein, the terms “about” and “substantially” are intended to include the degree of error associated with measurement of the particular quantity based upon the equipment available at the time of filing the application. For example, “about” can include a range of ±8% or 5%, or 2% of a given value. Similarly, “substantially” captures the concept of non-perfect or non-ideal, and thus allows for acceptable deviations that are suitable for a given feature and as understood by those of skill in the art to be acceptable. The terms “at least one” and “one or more” are understood to include any integer number greater than or equal to one, i.e., one, two, three, four, etc. The term “a plurality” is understood to include any integer number greater than or equal to two, i.e., two, three, four, five, etc. The term “connection” can include an indirect “connection” and a direct “connection”.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that embodiments of the present disclosure may include only some of the described aspects and features. Accordingly, the disclosure is not to be seen as limited by the foregoing description but is only limited by the scope of the appended claims.

What is claimed is:

1. A micro radio frequency (RF) connector plug, comprising:
an outer conductor comprising an outer conductor ring having a bottom end and a plurality of pins extending radially and outwardly about a circumference on the bottom end of the outer conductor ring, the outer conductor defining an axis therethrough;
an inner conductor arranged within the outer conductor, the inner conductor comprising a central needle arranged along the axis of the outer conductor and an extending needle arranged in a direction normal to the axis of the outer conductor, wherein the extending needle extends through a gap between two adjacent pins of the outer conductor and toward an outer side of the outer conductor ring; and
an insulator arranged to isolate the inner conductor from the outer conductor, the insulator comprising an outer ring, an inner ring, and a base connecting the outer ring and the inner ring, wherein the outer ring and the inner ring are arranged coaxially, an outer edge of the base is connected with a bottom end surface of the outer ring, and an inner edge of the base is connected with a bottom end surface of the inner ring, wherein the outer conductor ring is embedded between the outer ring and the inner ring of the insulator;
a first locking structure provided on an inner wall of the outer conductor ring; and
a second locking structure provided on an outer wall of the outer ring,
wherein the first locking structure and the second locking structure are configured to securely connect and lock the connector plug into connection with a connector receptacle.

2. The micro RF connector plug according to claim 1, wherein the first locking structure is a ring-shaped first groove, the first groove comprising a first side wall, a first upper wall, and a first lower wall, wherein the first side wall is arranged to be parallel to the axis of the outer conductor, the first upper wall inclines upwardly and forms an obtuse-angle structure with the first side wall, and the first lower wall inclines downwardly and forms an obtuse-angle structure with the first side wall.

3. The micro RF connector plug according to claim 2, wherein the second locking structure is a ring-shaped second groove, the second groove comprising a second side wall, a second upper wall, and a second lower wall, wherein the second side wall is angled relative to the axis of the outer conductor, the top end of the second side wall is arranged to incline to an inner side of the outer ring, and the second upper wall and the second lower wall are each arranged to be horizontal or normal to the axis of the outer conductor.

4. The micro RF connector plug according to claim 1, wherein:
a gap is defined between the outer ring and the inner ring of the insulator;
a bottom end surface of the outer conductor ring is positioned in the gap;
the plurality of pins extend radially outward from the base of the insulator;
a block extending inwardly is arranged on a top end surface of the inner wall of the outer ring, and
a top end surface of the outer conductor ring abuts a bottom surface of the block.

5. The micro RF connector plug according to claim 4, further comprising:
a ring-shaped groove defined on an inner side wall of the outer ring; and
a protrusion corresponding to the ring-shaped groove provided on an outer side wall of the outer conductor ring, wherein the protrusion engages with the ring-shaped groove.

6. The micro RF connector plug according to claim 1, further comprising:
a squared hole defined at a central axis of the inner ring, wherein the central needle is arranged inside the squared hole; and
a conical frustrum provided at a location where the central axis passes through a top surface of the inner ring, the conical frustrum comprising a through hole aligned with and in communication with the squared hole,
wherein a diameter of the through hole of the conical frustrum is smaller than a side length of the squared hole.

7. The micro RF connector plug according to claim 1, further comprising a notch formed on a side wall of the outer conductor ring, wherein the notch is arranged parallel to the axis of the outer conductor and runs through both the inner wall and an outer wall of the outer conductor ring.

8. The micro RF connector plug according to claim 1, wherein the plurality of pins are connected with the outer conductor ring by means of a rounded angle, and an opening is formed at the place of the rounded angle.

9. The micro RF connector plug according to claim 8, wherein the plurality of pins comprise four first pins and one second pin, wherein the four first pins are evenly distributed about a circumference of the outer conductor ring, the second pin is arranged to extend in a direction opposite the extending needle, and an opening is formed at a place of the rounded angle connection between a first pin and the outer conductor ring.

10. The micro RF connector plug according to claim 1, wherein the central needle and the extending needle are connected by a rounded angle, and a step is formed at a bottom end of the central needle.

11. A micro RF connector, comprising a plug according to claim 1 and a receptacle, wherein the receptacle comprises:
a housing;
an outer conductor; and
an inner conductor, wherein the housing, the outer conductor, and the inner conductor are arranged in an order from outside to inside,
wherein the housing is an insulator and one side wall of the housing is provided with an external hook;
an internal buckle is provided at a bottom end of the outer conductor of the receptacle, and
the inner conductor of the receptacle is arranged in contact and electrically connected with the inner conductor of the plug;
the external hook is engaged with the second locking structure, and
the internal buckle is engaged with the first locking structure.

12. The micro RF connector plug according to claim 1, wherein the connector plug is configured for connection between components on an automobile.

13. The micro RF connector plug according to claim 1, wherein the connector plug is configured for connection between components on farm equipment.

14. The micro RF connector plug according to claim 1, wherein the connector plug is configured for connection between components on a robotic assembly.

15. The micro RF connector plug according to claim 1, wherein the connector plug is configured for connection between components on a camera.

16. The micro RF connector plug according to claim 15, wherein the camera is part of an automobile.

17. A processing process of a micro RF connector plug, comprising:
processing one or more inner conductors along an inner conductor strip using continuous stamping;
processing one or more outer conductors along an outer conductor strip using continuous stamping;
placing stamped inner conductors located on the inner conductor strip in a lower mold of an injection mold;
placing stamped outer conductors located on the outer conductor strip in the injection mold, wherein the inner conductors and the outer conductors are arranged to oppose each other, a central needle of an inner conductor is placed at a central axis of an outer conductor, and a bottom surface of the inner conductor is arranged flush with a bottom surface of the outer conductor; and
injection molding an insulator, wherein the insulator is injection molded with the inner conductor and the outer conductor into an integral molded part.

18. The processing process of a micro RF connector plug according to claim 17, wherein the inner conductor strip comprises:
a first positioning part comprising a plurality of positioning holes evenly arranged thereon; and
a first stamping part,
wherein the process comprises processing one or more inner conductors by stamping the first stamping part;
wherein the processed first stamping part comprises a plurality of inner conductors and a plurality of first protection pins, wherein one first protection pin is provided between every two adjacent inner conductors and an extending needle of the inner conductor is connected to the first positioning part.

19. The processing process of a micro RF connector plug according to claim 18, wherein the outer conductor strip comprises:
a second positioning part comprising a plurality of positioning holes evenly arranged thereon; and
a second stamping part,
wherein the processes comprises processing one or more outer conductors by stamping the second stamping part;
wherein the processed second stamping part comprises a plurality of outer conductors and a plurality of second protection pins, wherein one second protection pin is provided between every two adjacent outer conductors and a second pin of the outer conductor is connected to the second positioning part; and
a spacing between the positioning holes on the first positioning part is equal to the spacing between the positioning holes on the second positioning part.

20. The processing process of a micro RF connector plug according to claim 18, wherein each first protection pin comprises:
a horizontal bottom plate;
a vertical plate that is vertically connected with the bottom plate; and
a horizontal reinforcing plate arranged at a top end of the vertical plate opposite the horizontal bottom plate,
wherein the reinforcing plate extends toward the first positioning part, and a length of the reinforcing plate is shorter than a length of the bottom plate.

21. A micro RF connector plug assembly, comprising:
one or more inner conductors arranged along an inner conductor strip;
one or more outer conductors arranged along an outer conductor strip, wherein the number of inner conductors equals the number of outer conductors;
wherein the inner conductors and the outer conductors are arranged to oppose each other and a central needle of each inner conductor is placed at a central axis of a respective outer conductor, and a bottom surface of the inner conductor is arranged flush with a bottom surface of the outer conductor; and
an insulator injection molded with the inner conductor and the outer conductor to form an integral molded part.

22. The micro RF connector plug assembly according to claim 21, wherein the inner conductor strip comprises:
a first positioning part comprising a plurality of positioning holes evenly arranged thereon; and
a first stamping part comprising a plurality of inner conductors and a plurality of first protection pins, wherein one first protection pin is provided between every two adjacent inner conductors and an extending needle of the inner conductor is connected to the first positioning part.

23. The micro RF connector plug assembly according to claim 22, wherein the outer conductor strip comprises:
a second positioning part comprising a plurality of positioning holes evenly arranged thereon; and
a second stamping part comprising a plurality of outer conductors and a plurality of second protection pins, wherein one second protection pin is provided between every two adjacent outer conductors and a second pin of the outer conductor is connected to the second positioning part.

24. The micro RF connector plug assembly according to claim 23, wherein a spacing between the positioning holes on the first positioning part is equal to the spacing between the positioning holes on the second positioning part.

25. The micro RF connector plug assembly according to claim 21, wherein each first protection pin comprises:
a horizontal bottom plate;
a vertical plate that is vertically connected with the bottom plate; and
a horizontal reinforcing plate arranged at a top end of the vertical plate opposite the horizontal bottom plate,
wherein the reinforcing plate extends toward the first positioning part, and a length of the reinforcing plate is shorter than a length of the bottom plate.
